(19) United States
(12) Patent Application Publication
(10) Pub. No.: US 2002/0060683 A1
(43) Pub. Date: May 23, 2002

(54) Method and apparatus for creating activatibility criteria in time for elements of a video sequence

(75) Inventors: Tilman Hampl, Waldbuttelbrunn (DE); Winfried Piegsda, Eggenstein-Leopoldshafen (DE); Ralph Sonntag, Kunzell (DE)

Correspondence Address: MICHAEL BEST & FRIEDRICH, LLP, 100 E WISCONSIN AVENUE, MILWAUKEE, WI, 53202, US

(73) Assignee: active-film.com AG, Frankfurt am Main (DE)

(21) Appl. No.: 09/930,381

(22) Filed: Aug. 15, 2001

(30) Foreign Application Priority Data
Aug. 16, 2000 (EP) 00117654.4

(51) Int. Cl. G06T 1/00

(52) U.S. Cl. 345/501

(57) ABSTRACT

The invention relates to a method and an apparatus for computer controlled administration of interactivity for elements 11, 12 and 15 of a video sequence 10, wherein the elements 11, 12 and 15 are audio, visual or content related elements, the method comprising associating an identifier to the elements 11, 12 and 15 of the video sequence 10, which is potentially activatible, and setting timestamps for the identifier as activatibility criteria for the associated element 11, 12 and 15 in response of an action of processing person of the video sequence 10 upon its reproduction.

### BACKGROUND OF THE INVENTION

1. Field of the invention

The invention relates to a method and an apparatus for computer controlled administration of interactivity of elements in a video sequence according to the preamble part of claim 1.

2. Description of the related prior art

Due to the economic interest of marketing and sales departments to guide a customer to products or information in a simple and attractive manner, the increasing number of different reproduction platforms for video sequences and the possibility to receive video sequences over the internet, interactivity in video sequences becomes a major factor in the processing of video sequences.

FIG. 1 illustrates the basic principles for creating interactivity for an element 11, 12 or 15 of a video sequence 10. The video sequence 10 for example comprises a picture sequence 13 and an audio sequence 14. In an apparatus for creating interactivity 20 activation properties 21 and 22 for the elements 11 and 12 are fixed and activatable objects 31 and (12+22) are created. The activatable objects 31, (12+22) are incorporated into the video sequence 10 for providing interactivity in the reproduction platform 30. Therein the picture sequence 13 is displayed in a displaying unit 33 with the activitable object 31 and the activitable area 22, while the audio sequence 14 is replayed in an audio reproduction unit 34 as a sequence of sounds. The non-illustrated viewing person may activate the activatable object 31 or (12 +22) by means of actions of the indicating unit 35. The activation properties 21 and 22 can comprise different events for various actions of the viewing person. If the viewing person points out to the activatable object 31 by means of the indicating unit 35, an informative text for the element 11 can be displayed. Upon further pressing a button on the indicating unit 35, a short non-illustrated video sequence comprising further activatable objects can be displayed wherein reproduction of the video sequence 10 is continued after the end of this short video sequence.

As indicated in FIG. 1, the elements of the video sequence may be visual (building 11) or audio (sound sequence 12) but also content related (happiness or friendship) elements. The common methods for creating interactivity for elements of a video sequence are directed to visual elements.

FIG. 3 illustrates a prior art method for administering interactivity of a video sequence's elements. In the creation unit 20 for an element of the video sequence 10, which is intended to be activatable, the positional arrangement of the element is determined in a unit 25 for recording of co-ordinates and the positional arrangement of the element in its temporal development is monitored in a unit 24 for movement recognition. In an activation property determination unit 26 the activation properties for the element are determined. Together with the positional information from the units 24 and 26 the activation properties are incorporated into the video sequence in an insertion unit 23. Depending on the requirements for a reproduction platform 30 the video sequence 10 is transferred thereto together with the incorporated activatable object 31 or separated thereof.

For recognising the movement of an element different methods are known in the prior art, which all include respective disadvantages. Activation properties can be associated with the element picture by picture in a manual process. This requires an enormous amount of work and includes various possibilities for errors. In semiautomatic processing the activatable object is created for a selection of main frames of the video sequence only. Then the movement between the main frames can be automatically calculated as long as the element moves on mathematically simply to define paths. Upon increased calculation expenses the necessary manual processing thereby is reduced. Starting from a basic form of the element a pattern recognition method automatically records the element frame by frame and thereby traces the movement of the element in the video sequence. The pattern recognition becomes particularly difficult through the fact, that the element may change its representation in the video sequence. Thereby even in simple video sequences a high amount of computation is necessary. For example, a pattern recognition for a person for which the shown portion, the used perspective or its deportment are changing would become extremely difficult.

A further problem arises, if an element that should be activated is shown in the video sequence for a time being too short or a movement of the element being too fast to be recognised and activated by a viewer of the video sequence. Depending on the viewer and the reproduction platform a maximum speed of movement or a minimum period of activatibility, which makes sense, for an activitable object may differ. Reproduction platforms may for example differ in screen size, resolution, reproduction speed, activation possibilities, operating system, computer program for reproduction of the video sequence or different versions thereof.

Due to the possible differences between the reproduction platforms, a video sequence has to be adapted to the specific format of the reproduction platform. The conversion of existing video sequences comprising activatable objects for different reproduction platforms can only be performed in certain limits. In contrast thereto, a format specific creation of versions of the video sequence for different reproduction platforms in a prior art method requires repetition of the most work intensive steps of the method.

### SUMMARY OF THE INVENTION

It is the object of the invention to provide a method and an apparatus simplifying the administration of interactivity for audio, visual or content related elements of a video sequence in view of moveable elements and different reproduction platforms.

This object is solved by a method comprising the steps according to claim 1. The dependent claims illustrate preferred embodiments of the invention.

According to the invention an identifier is associated with a potentially activatable element of the video sequence, and upon reproduction of the video sequence timestamps are set for the identifier as activatibility criteria for the associated element in response to an action of a person processing the video sequence. The advantages of this method are the simplified operating, the scalibility of the timestamps or timing marks for different reproduction platforms and the similarity of the method to a viewers later activation of activatable objects. The processing person, similar to the viewing person, has to recognise the element and correspondingly perform an action. The timestamps thereby will be adapted even better to the situation of the viewing person.

According to a preferred embodiment of the method the setting of the timestamps is performed in response to a keyboard input of the processing person. The keyboard input allows to set a first time stamp, when the key is pressed, for marking the start of an activatibility period and a second time stamp can be set, when the key is released, for marking the end of the activatibility period. The processing person may press a plurality of keys in parallel to thereby set a plurality of timestamps. Alternatively the start timestamp may be set by a first key stroke and the end time stamp by a second key stroke of the same or another key.

It is particularly suitable to indicate the appearance of a potentially activatable element for the processing person by means of a text or a press button, for allowing a faster processing of the video sequence and for example upon repeated reproduction of the video sequence for characterising already activatable elements with the corresponding text or press button for the processing person.

According to an advantageous embodiment of the method the timestamps are administered independently from the positional information of the element. Thereby the need to recognise the elements in their position is avoided. Furthermore, audio visual or content related elements do not have to be distinguished in the administration process.

According to a preferred embodiment of the method the reproduction of the video sequence is performed in a moving image manner, thereby the processing speed is increased. Particularly when reproducing in real time, for the processing person the identical situation as for the viewer of the video sequence is achieved. Furthermore, the processing person can adapt the reproduction speed, particularly faster or slower than real time, to the actual processing speed of the video sequence.

It is particularly advantageous to administer the timestamps and the activation properties for the element separated from the video sequence, whereby the creation of video sequences for different reproduction platforms is simplified.

According to a further embodiment of the method a link to the separately administered timestamps or activation properties of the element is stored in the video sequence. Thereby the incorporation of activatable objects in the video sequence is facilitated.

According to a further preferred embodiment of the method a minimum length for activatibility periods is monitored. Activatibility periods being too short to be recognised by a viewing person thereby can be extended by semiautomatic movement of the timestamps. According to a preferred embodiment of the method also a minimum distance in time for activatibility periods is monitored and achieved by joining activatibility periods. Thereby it can be avoided that acitivatable objects may be not activatable for a short time, which a viewing person may interpret as an error in the video sequence.

According to a particularly advantageous embodiment of the method an activatable object is created for a reproduction platform having a specific format for video sequences based on the timestamps and format specific activation properties. Video sequences with activatable objects thereby become individually creatable for different reproduction platforms based on the same information. Additionally the method maybe repeated anytime, can be performed in response to a request and allows the optional use of positional information about the element or the activatable object by means of the activation properties.

According to a preferred embodiment for realising one of the pre-described methods a computer controlled apparatus is used, whereby a fast processing and an optimised embodiment of the method becomes possible.

Further, according to the invention, a storage medium may include a computer program or an instruction sequence for realising one of the above methods. Thereby, the method being implemented once can be used in a plurality of apparatuses at various locations.

### BRIEF DESCRIPTION OF THE DRAWINGS

In the following preferred embodiments of the invention are described with reference to the figures illustrating:

FIG. 1 a basic concept for creating interactivity of an element of a video sequence.

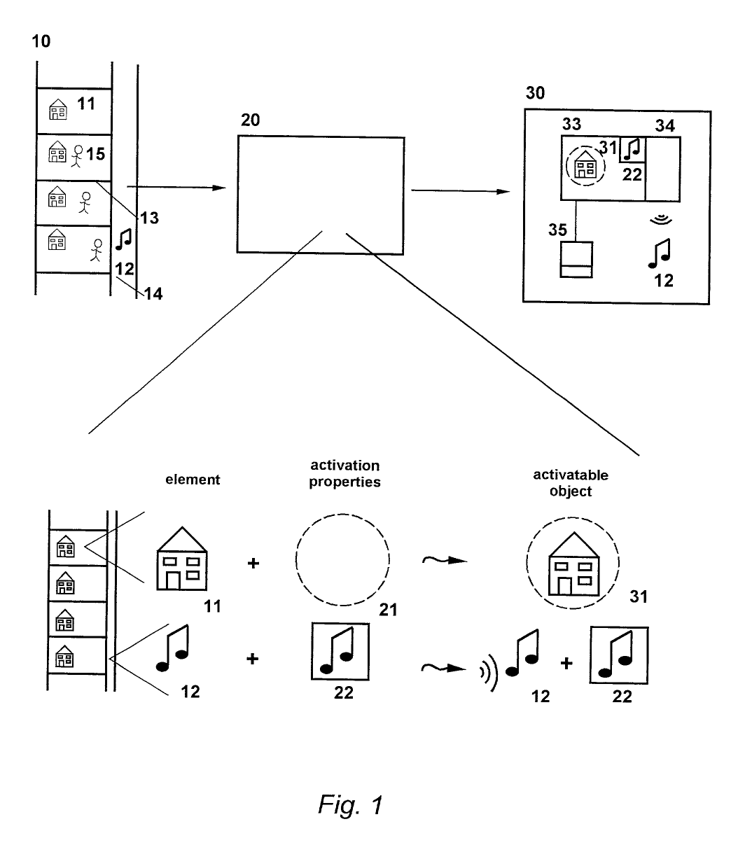

FIG. 2 a representation of the method for the administration of an element of a video sequence in a preferred embodiment of the invention and

FIG. 3 a representation of the prior art method for administering interactivity of elements of a video sequence.

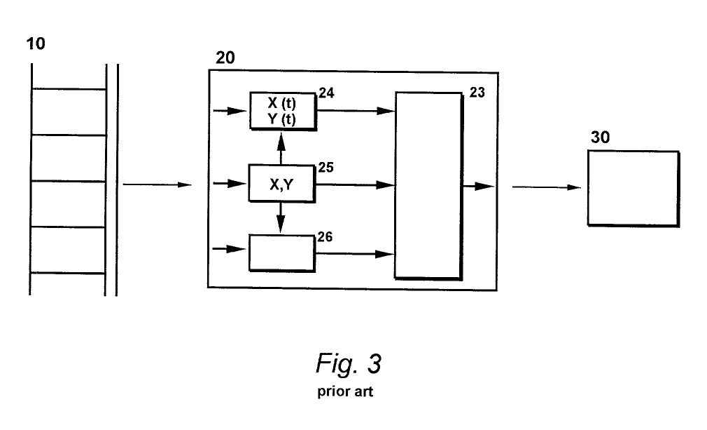

### DETAILED DESCRIPTION OF THE INVENTION

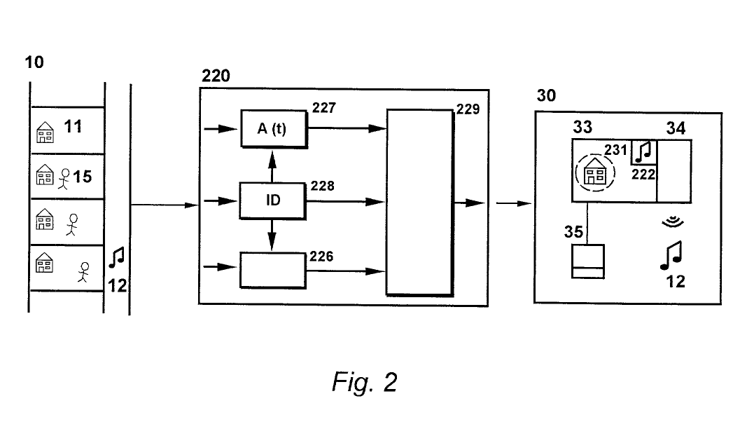

FIG. 2 illustrates a preferred embodiment of the invention. In creation means 220 the video sequence 10 is provided with activatable objects for being reproducible in the reproduction platform 30. The video sequence 10 comprises a picture sequence 13 and an audio sequence 14. The creation means 220 particularly can be a part of a computer a video processing interface or a motion picture processing means. The existing processing means essentially determines the embodiment of the method. A computer in particular may comprise a displaying unit, a keyboard, a mouse, a controlling unit, a hard disk and a drive for optical or magnetical storage media. In the following we will assume that the creation means 220 is a computer.

The video sequence 10 comprises for example a commercial for a shop 11 selling music, and it may exist as a frame oriented motion picture, video tape or in digitised or additionally compressed form. First, for those elements, intended to be potentially activatable, an identifier is associated thereto in an associating unit 228. A simple number may be used as identifier, but moreover an unambiguous name may also be selected as identifier. For example, in the commercial the identifiers “music shop” for element 11, “music title” for element 12 and “customer” for element 15 appear to be suitable. These identifiers are stored for example in an external database. For allowing the non-illustrated processing person to set timestamps for the elements, the action for the elements setting these timestamps have to be determined. For example, a pressing of the key: “g” for music shop, “t” for music title or “k” for customer.

According to the invention a start timestamp for the activatibility of element 11 is set in a timestamp unit 227, when the processing person presses the key “g” upon reproduction of the video sequence 10. Accordingly an end time stamp is set when the processing person releases the key “g”. The processing person recognises the element 11 in the video sequence and performs the action associated to this element for setting the time stamp. A starting time and an end time for the activatibility of the associated element can be used as timestamps, but it is also possible to use a starting time and an activatibility period, or even use the frame numbers from the video sequence as timestamps. For example, touching a touch-sensitive screen at a position associated to the element or even speech recognition for the identifier (“music title”) of the element also appears to be possible as an action of the processing person. Furthermore, the setting of timestamps may be performed in response to detectable gestures of the processing person.

The appearance of a potentially activatable element 11, 12 and 15 is indicated for the processing person by means of a press button. Thereby the processing person recognises the appearance of the activatable element even faster and may determine the activatability state of the element based on the press button. The press button will be indicated as pressed down for a period in time, in which the processing person has already indicated activatibility for the element 11 in a previous reproduction of the video sequence.

The timestamps are associated to the identifier and are stored for example in an external database. Thereby the timestamps are independent of any positional information about the element whose activation criteria they are. Thus, a recognition of co-ordinates of the elements, their size or movement is not necessary. Furthermore the processing person may even make e.g. the element 12 activatable before it is reproduced or can be heard in the video sequence for particularly emphasising it. He may even include an additional standard product of music shop 11 which is not enclosed in this video sequence, but presented to the processing person as an additional activatable object for any commercial produced for this music shop. Thus, the activatibility of the element can be completely independent from the reproduction of the element in the video sequence.

The video sequence 10 is reproduced in a moving image like or full motion image manner, particularly in real time, for providing a similar situation for the processing person as for the later viewer thereof. Therein the processing person can control the reproduction speed to a slower or faster speed than real time and thereby select a processing speed adapted to the video sequence. For example, if in the first part of the commercial only the music shop 11 is intended to be an activatible element, then this part of the video sequence can be processed faster than a more complex part thereof e.g. comprising different music titles shortly replayed in parts one after another, which all should be made activatible. The processing person may, for example upon reduced reproduction speed, press one key for each new music title and keep them pressed until releasing them altogether. Thereby timestamps starting with each title are produced, the activatibility periods existing in parallel and continuing even after the end of the respective music title. This can be achieved by storing the timestamps in an external database or by adding a separate track to the video sequence for each activatibility period.

In an unit 226 the activation properties e.g. for the element 11 and 12 are determined. Besides viewer actions with associated events, for example a visual representation, but even positional information may be comprised in the activation properties for the element.

Preferably, in the video sequence a link is stored to the timestamps or activation properties of the elements stored in an external database. By the separated administration of timestamps and activation properties this information can be easily altered and clearly arranged. For the processing person for example a list of timestamps or activation properties may be displayed and provided for editing.

Preferably, a minimum length for activatibility periods is monitored to avoid activatable objects in the video sequence, which are practically unactivatable for a viewing person. The minimum length can be enforced automatically and achieved by moving the end time stamp or indicating a warning message to the processing person. Furthermore, if plural activatibility periods in time for one element exist, a minimum distance in time between these activatibility periods may be monitored and guaranteed by joining those if required. The joining of the activatibility time periods also can be performed automatically or in connection with a warning message to the processing person.

In an insertion unit 229 an activatable object 231 or (12+222) for a reproduction platform 30 having a specific format for reproducing video sequences is created based on the timestamps and format specific activation properties. The reproduction platform 30 can differ in a variety of software or hardware properties from each other. Digital videos for example can be reproduced on a computer by means of the software “Quick Time” or “Windows Media Player”. The reproduction platform 30 illustrated in FIG. 2 comprises a screen 33, for example for reproducing an activatable object 231 and an activatable surface 222, a sound reproduction unit 34 for example for reproducing the sound sequence 12 and at least an interface to the viewer for example a mouse 35. For example a computer, a mobile telephone, video games means, a television comprising respective additional functions or a television in combination with reproduction means such as a video recorder can be used as reproduction platforms 30.

A computer controlled apparatus comprising means to realise one of the above methods, can depend in its implementation on the video sequences input format.

The computer program realising one of the above methods can be stored on a hard disk of the computer or a magnetical or optical storage medium.

What is claimed is:

1. A method for computer controlled administration of interactivity elements of a video sequence, wherein the elements are audio, visual or contents-related elements, the method comprising:
associating an identifier with an element of the video sequence, which potentially should be activatable;
characterised by
setting timestamps for the identifier as a criteria for the activatability of the associated element, in response to an action of a person processing the video sequence upon its reproduction.

2. The method according to claim 1 characterised in that the setting of timestamps is performed in response to a keyboard input of the processing person.

3. The method according to claim 1 characterised in that the timestamps are administered independent from positional information of the element.

4. The method according to claim 1 characterised in that the reproduction of the video sequence in is performed in moving image manner.

5. The method according to claim 1 characterised in that the timestamps and the activation properties of the elements are administered separated from the video sequence.

6. The method according to claim 1 characterised in that the appearance of a potentially activatable element is indicated for the processing person by means of a text or a press button.

7. The method according to claim 5 characterised in that a link to the separately administered time stamp or activation properties of the elements is stored in the video sequence.

8. The method according to claim 1 characterised in that a minimum length for activatibility periods is monitored.

9. The method according to claim 1 characterised in that a minimum time distance for activatibility periods is monitored and realised by joining activatibility periods.

10. The method according to claim 1 characterised by creating an activatable object for a reproduction platform having a specific format by means of the timestamps and formats specific activation properties.

11. Computer controlled apparatus comprising means for realising a method according to claim 1.

12. Storage medium comprising a computer program or instruction sequence realising a method according to claim 1.
